(19) United States
(12) Patent Application Publication
(10) Pub. No.: US 2020/0178727 A1
(43) Pub. Date: Jun. 11, 2020

(54) Temperature Adjustment Unit for Fuel-Burning Grill

(71) Applicant: Premier Specialty Brands LLC, Duluth, GA (US)

(72) Inventor: Robert Brennan, Duluth, GA (US)

(73) Assignee: Premier Specialty Brands LLC, Duluth, GA (US)

(21) Appl. No.: 16/704,076

(22) Filed: Dec. 5, 2019

Related U.S. Application Data
(60) Provisional application No. 62/776,547, filed on Dec. 7, 2018.

(51) Int. Cl. A47J 37/07; F24C 15/32

(52) U.S. Cl. CPC A47J 37/0754; A47J 2202/00; F24C 15/322; A47J 37/0786

(57) ABSTRACT

Embodiments of the present disclosure include a temperature adjustment unit comprising a fan combining the benefits of both a blower fan and a starter fan into a single unit for use in a fuel-burning device. The temperature adjustment unit can be mounted proximate an inlet of the fuel-burning device and comprise means for adjusting the settings of the fan to various modes.

### CROSS-REFERENCE TO RELATED APPLICATIONS

This application titled “Temperature Adjustment Unit For Fuel-Burning Grill” is a non-provisional application claiming the benefit to Provisional Application No. 62/776,547 filed Dec. 7, 2018 and titled “Temperature Adjustment Unit for Fuel-Burning Grill,” which is hereby incorporated by reference in its entirety as if set forth below.

### TECHNICAL FIELD

Embodiments of the present disclosure relate to a temperature adjustment unit for a fuel-burning grill and more particularly a temperature adjustment unit comprising a fan operating in a plurality of modes to regulate the internal temperature of a fuel-burning grill.

### BACKGROUND

It is known that the temperature within the cooking chamber of a fuel-burning device (referred to herein as a “grill”) can be adjusted or controlled by positioning a fan adjacent to or within an inlet in the grill base. The fan, when engaged, pushes oxygen-containing air into the cooking chamber containing burning fuel (e.g., charcoal or wood chips). The greater the oxygen supply to the burning fuel, the more vigorously the fuel will burn, resulting in increased fire intensity and thus an increased temperature within the cooking chamber.

A relatively weak fan can be used to regulate the internal temperature of the grill by providing soft puffs of oxygen-bearing air to the fuel. This may be achieved by, for instance, using a blower fan to provide airflow of about ten (10) ft³/minute (approximately 0.3 m³/minute). When the temperature needs to be increased, the fan can be turned on and provide the soft airstream through a grill inlet and into the cooking chamber. The typical blower fan attaches on the outside of the grill base. These fans, however, operate at a constant speed, with temperature controlled by turning the fan either on or off.

It is also known in the art to utilize a much more powerful fan when starting the fuel burning. This fan acts like a bellows and provides a much stronger stream of air to the cooking chamber, and thus to the fuel as it is being started. It is desirable to provide a much greater flow of oxygen to a fire that is just beginning to burn to enable the fuel to burn more quickly and achieve maximum charcoal coverage. Starter fans are known in the art, but they are accessories that do not attach to the grill base directly. They operate more like a directional fan set proximate the grill inlet but not mounted to the grill base.

Currently, there are not fan units that combine these functionalities into the same unit and there is a desire for fan units that provide a means for more precisely monitoring and controlling the temperature in the cooking chamber. The presently disclosed embodiments are directed to these and other objectives.

### SUMMARY

Embodiments of the present disclosure include a multi-modal fan combining the benefits of both a blower fan and a starter fan into a single unit for use with a grill. In some embodiments, the multi-modal fan can be integrated into a temperature adjustment unit comprising a control unit, a casing, and a fan. The temperature adjustment unit can serve the objectives of attaching the multi-modal fan to the grill base and providing means for adjusting the speed of the fan and therefore airflow strength produced by the fan. This in turn helps adjust and control the temperature within the cooking chamber of the grill.

In some embodiments, the temperature adjustment unit may comprise a track for sliding the fan into and out of place about a grill inlet. The temperature adjustment unit can be attachable to the grill base and may be operated manually or remotely via the control unit. In some embodiments, the control unit can comprise a wireless communication device configured to wirelessly communicate with a mobile device such that the temperature adjustment unit can be operated remotely via a mobile application.

Because of the high temperatures at which grills operate, some components or all components of the temperature adjustment unit may be made out of a heat-resistant material.

### BRIEF DESCRIPTION OF THE DRAWINGS

FIGS. 1A and 1B are exploded views of a temperature adjustment unit, according to some embodiments of the present disclosure.

FIG. 1C is a back view of a temperature adjustment unit, according to some embodiments of the present disclosure.

FIG. 1D is a front perspective view of a temperature adjustment unit, according to some embodiments of the present disclosure.

FIG. 2 illustrates a temperature adjustment unit attached to the body of a fuel-burning grill, according to some embodiments of the present disclosure.

FIG. 3 illustrates another embodiment of a temperature adjustment unit, according to some embodiments of the present disclosure.

FIG. 4 illustrates a system in which a temperature adjustment unit is in wireless communication with a user device, according to some embodiments of the present disclosure.

### DETAILED DESCRIPTION

Typical fuel-burning grills, such as kamado-style grills, have an inlet proximate the base of the grill through which air can enter and vent. The amount of air entry permitted is useful in adjusting and controlling the temperature within the cooking chamber of the grill. For instance, if it is desired to increase the temperature within the cooking chamber, air can be introduced to the inlet which rises through the cooking chamber, interacts with the fuel within the grill, and causes the fuel to burn more rapidly. Otherwise, if it is desired to maintain or control the temperature within the cooking chamber, air contact with the fuel can be decreased and held constant. Generally, air is introduced to the interior of the grill through a controlled inlet that can be increased and decreased in size as needed.

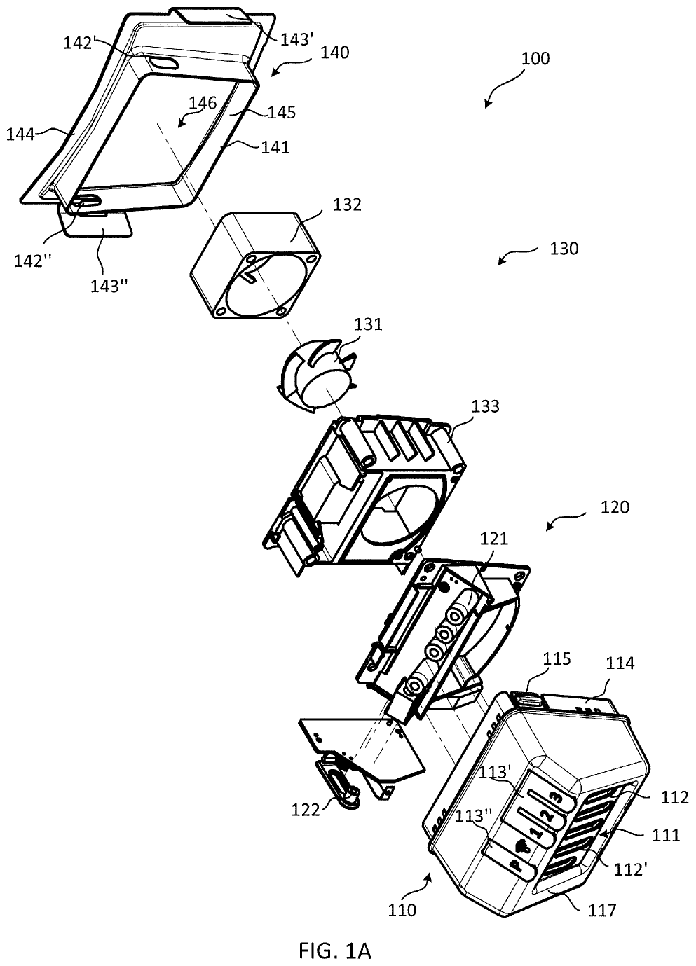

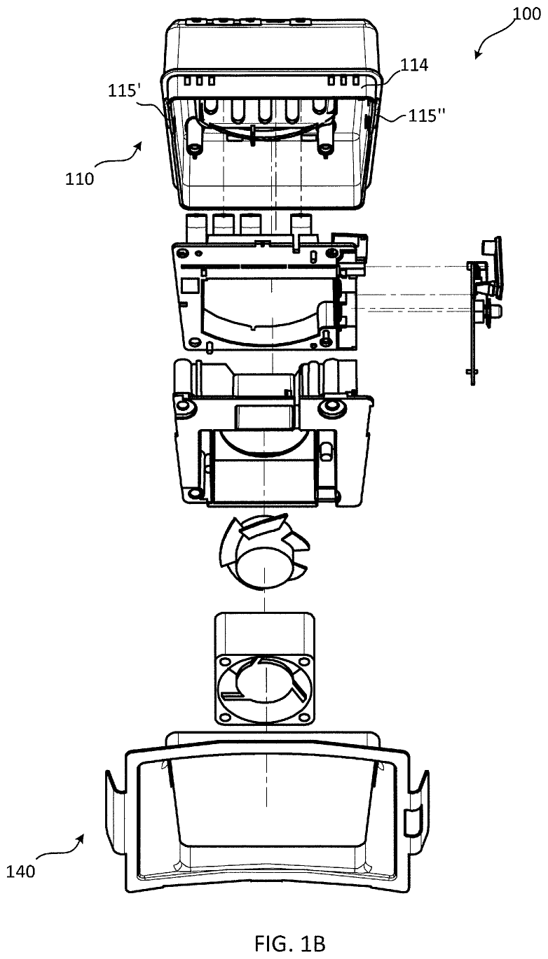

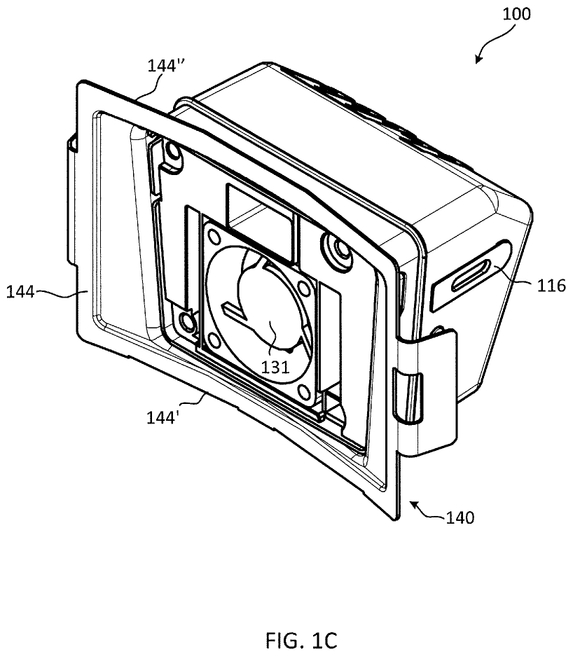

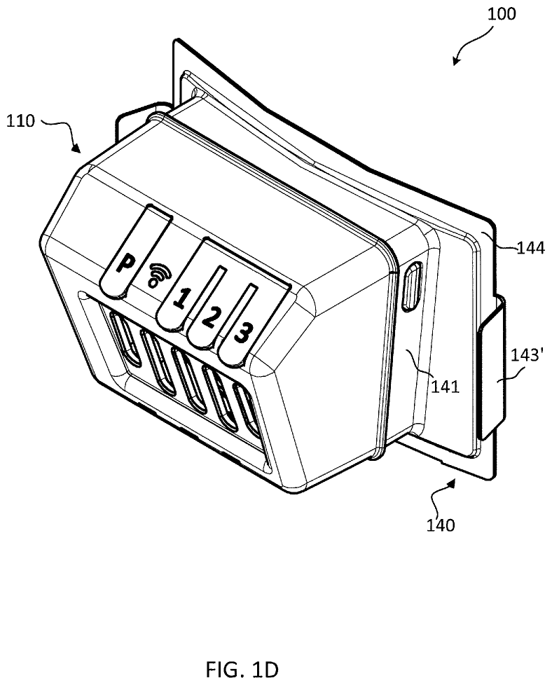

FIGS. 1A-1D illustrate an embodiment of a temperature adjustment unit 100. The temperature adjustment unit 100 comprises a fan unit 130 capable of operating at a plurality of modes, and that for instance, combines the benefits of both a blower fan and a starter fan into a single unit for use in a fuel-burning grill. As mentioned above, a blower fan is a fan that provides puffs of air to the cooking chamber of the fuel-burning grill to provide temperature maintenance or regulation during cooking. A starter fan, on the other hand, provides a steady flow of air to the fuel to assist with starting a fire and heating the cooking chamber.

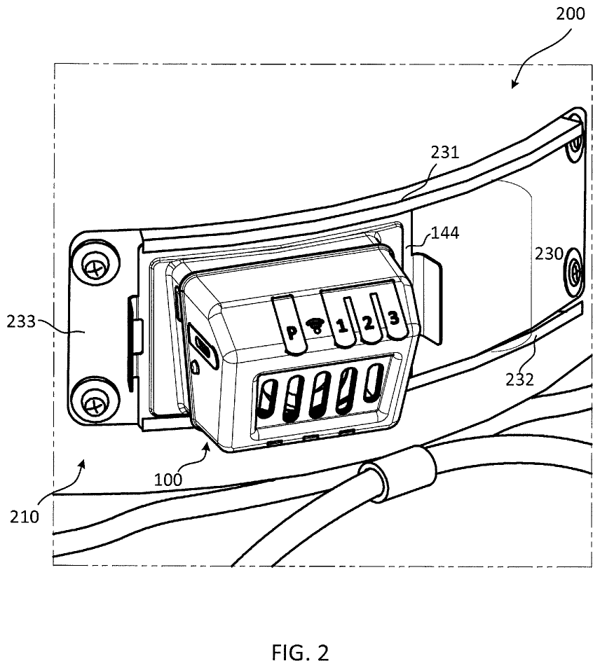

As illustrated in FIGS. 1A-1B, the temperature adjustment unit 100 can comprise an outer casing 110, a control unit 120, a fan unit 130, and an attachment unit 140. When in assembled form, as illustrated in FIGS. 1C and 1D, the outer casing 110 can enclose the control unit 120 and fan unit 130 to protect the control and fan units from high temperatures and other environmental elements. The outer casing 130 can also couple with the attachment unit 140, to allow for attachment of the temperature control unit 100 to a fuel-burning grill (as illustrated for instance in FIG. 2).

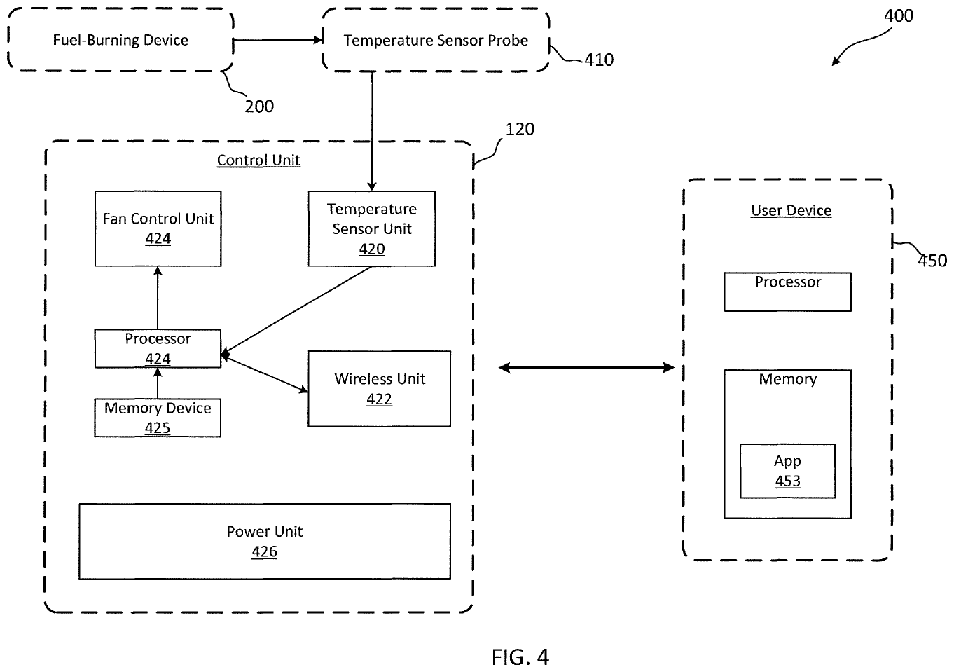

The outer casing 110 can comprise a vent 111 disposed in a front face 117 of the outer casing 110, as illustrated for instance in FIG. 1A. The vent 111 can comprise a vent face 112 inset from the front face 117 of the outer casing 110 and a plurality of slits 111′ within the vent face 112 through which air can exhaust and protect the temperature adjustment unit 100 from overheating. The outer casing 110 can also comprise a plurality of top plug covers 113′, 113″ disposed on an upper portion of the outer casing 110. The plurality of top plug covers 113′, 113″ can be disposed over plugs (not shown) for receiving temperature sensor probes (as discussed in greater detail with respect to FIG. 4). In some embodiments, the top plug covers 113′, 113″ can be flipped upward and hinge along a connecting interface 113′″ to expose the plugs underneath. Additionally, the outer casing 110 can comprise a side cover 116 disposed over a plug (not shown) for receiving a power cord.

The outer casing 110 can further comprise a connecting member 114 for attaching to a corresponding receptacle 141 of the attachment unit 140. In some embodiments, as illustrated in FIGS. 1A and 1B, the connecting member 114 can comprise a hollow extension of the outer casing 110 (as illustrated in FIG. 1B) comprising two oppositely-positioned pressure-release buttons 115′ and 115″ configured to snap into a correspondingly shaped hole (142′ and 142″) of the attachment unit 140. When the outer casing 110 is connected to the attachment unit 140, the outer casing 110 can substantially enclose the fan unit 130 and the control unit 120.

FIGS. 1A and 1B further illustrates a fan unit 130 of the temperature adjustment unit 100. The fan unit 130 can comprise a rotor 131, a rotor housing 132, and a fan control system 133. In some embodiments, the fan control system 133 can comprise an electric motor (not shown) for controlling the speed of the rotor 131. The fan control system 133 can be operably coupled to the control unit 120 (as illustrated for instance in FIG. 4) such that the fan control system 133 can be caused to control the speed of the rotor 131. In some embodiments, the fan control system 133 can automatically adjust the speed of the rotor 131 based on temperature adjustment measurements made by the temperature adjustment unit. In other embodiments, the speed of the rotor 131 can be remotely adjusted such as from a user device.

In some embodiments, the fan unit 130 can be capable of operating at variable speeds. In some embodiments, the fan unit 130 may be continuously adjustable along a spectrum of speeds ranging from 0 ft³/minute to 30 ft³/minute. The fan unit 130 may first be configured to operate as a starter fan. When operating as a starter fan, the fan unit 130 may be automatically put in a high mode (e.g., approximately 30 ft³/min) to provide a steady flow of air to the cooking chamber. In other embodiments, the fan unit 130 may comprise pre-set speeds, for instance “off,” “slow,” “medium,” and “high.” In embodiments where the fan unit 130 can comprise pre-set speeds, “off” may indicate that the fan is off and therefore not blowing air; “slow” may indicate that the fan is blowing air at a slow rate (e.g., 10 ft³/min); “medium” may indicate that the fan is blowing air at a medium rate (e.g., 20 ft³/min); and “high” may indicate that the fan is blowing air at a high rate (e.g., 30 ft³/min).

In some embodiments, as discussed below, the fan unit 130 may have a power setting that automatically puts the fan in a high mode as a starter fan and alternative settings for decreasing the speed of the fan as desired. Utilizing a variable speed fan can allow the fan unit 130 to operate at the maximum speed as a bellows fan when put into a start-up mode or a blower fan when put in various lower speeds.

FIGS. 1A-1D further disclose an attachment unit 140 for attaching the temperature adjustment unit 100 to the fuel-burning grill. The attachment unit 140 can comprise a receptacle 141 for receiving the connecting member 114 of the outer casing 110 and a frame 144 comprising handles 143′, 143″.

In some embodiments, as illustrated in FIG. 1A, the receptacle 141 can comprise a wall 145 enclosing a hollow space 146 corresponding to the shape of the connecting member 114 of the outer casing 110 such that the connecting member 114 can be placed within the hollow space 146. The receptacle 141 can comprise holes 142′, 142″ on opposite sides of the hollow space 146. When the connecting member 114 is placed within the hollow space 146, the pressure-release buttons 115′, 115″ can fit into the holes and secure the connecting member 114 within the receptacle 141 of the attachment unit.

As illustrated in FIG. 1A-1D, the frame 144 of the attachment unit 140 can comprise a top edge 144′ and a bottom edge 144″ for slidably engaging with the track (depicted in FIG. 2). The frame can further comprise handles 143′, 143″ for moving the temperature adjustment unit 100 along the track. In some embodiments, the attachment unit 140 can be slightly curved so as to fit securely on the side of the fuel-burning grill.

As illustrated in FIG. 1D, the fan unit 130 can be disposed within the temperature adjustment unit 100 below the vent 111′ of the outer casing 110. The rotor 131 of the fan unit 130 can be disposed proximate a back of the temperature adjustment unit 100 such that it can have direct access to the inlet of the grill body 210. As such, when the temperature adjustment unit 100 is disposed proximate an open inlet of the grill body 210, the fan unit 130 can provide airflow through the inlet and into the cooking chamber. This may be useful to increase or decrease the temperature within the cooking chamber.

FIG. 2 illustrates a temperature adjustment unit 100 attached to a grill body 210 of a fuel-burning grill 200, according to some embodiments of the present disclosure. The temperature adjustment unit 100 can attach to a track system 230 via the attachment unit 140 of the temperature adjustment unit 100. The track system 230 can comprise a top rail 231 and a bottom rail 232 and a plate fixed to the grill body 210. As such, the top and bottom edges 144′,144″ of the frame 144 can slidably engage with the respective top and bottom rails 231, 232. The track system 230 may provide a user easy access to the inlet or the ability to adjust the temperature without use of the fan (for instance, by opening and closing a louvered assembly disposed proximate the inlet). The temperature adjustment unit 100 can thus be slid along the rails 231, 232 of the track system 230 to expose or cover the opening.

To not adversely affect the cooking characteristics of the grill, in some embodiments, the grill inlet on which the temperature adjustment unit 100 attaches can be relatively small, having dimensions corresponding to about the size of the rotor housing 132 and in an example embodiment, of about three inches to about four inches in height and width.

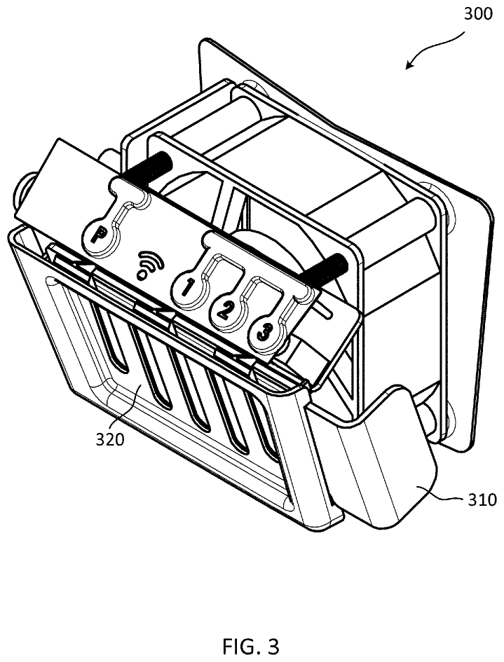

FIG. 3 illustrates another embodiment of a temperature adjustment unit 300 in a partially disassembled state. In this embodiment, the temperature adjustment unit 300 further comprise a vent cover 310 that is slidable behind the vent 320 of the temperature adjustment unit 300.

The control unit 120 can provide for operation of the temperature adjustment unit 100. FIG. 4 illustrates an example system 400 of the various devices making up the control unit 120 and the various external devices in which the control unit 120 communicates. The control unit 120 can comprise many of the same aspects and devices of conventional control unit devices. As illustrated in FIG. 4, in some embodiments, the control unit 120 can comprise a temperature sensor unit 420, a wireless unit 422, a fan control unit 424, a processor 424, a memory device 425, and a power unit 426. The control unit 120 can also be in communication with various devices including a plurality of temperature sensor probes 410 and a user device 450.

The temperature sensor unit 420 can be a device that receives temperature data from the temperature sensor probe 410. The temperature sensor unit 420 can relay the temperature data to the processor 424 that executes logic stored by the memory device 425 to cause the wireless unit 422 to transmit the temperature data to the user device 450.

In some embodiments, the processor 424 can execute logic stored by the memory device 425 to cause the fan control unit 424 to operate the fan unit 130 in a specific mode, for instance as a starter mode or in a blower mode. In some embodiments, the control unit 120 may do so automatically based on the temperature data collected by the temperature sensor unit 420. For instance, based on temperature data obtained by the temperature sensor unit, the processor can determine whether to increase or decrease the temperature within the cooking chamber and do so by adjusting the speed of the fan unit 130. In other embodiments, the control unit may do so based on an instruction received from the user device 450 indicative of a mode type desired by the user. For instance, a user may monitor the temperature within the cooking chamber on a user device (e.g., through a mobile application), and determine whether to turn the fan unit 130 on or off or adjust the fan speed. Such instructions can be transmitted from the user device to the control unit 120 to cause the control unit 120 to operate the fan unit 130 in accordance with the user's instructions.

In a preferred embodiment, the control unit 120 can allow for remote operation of the temperature control unit 100 through a user device 450 (e.g., mobile phone, tablet, personal computer, desktop computer). In such embodiments, the control unit 120 can comprise a wireless unit 422 such that the temperature adjustment unit 100 can be wirelessly coupled to the user device 450. In some embodiments, the wireless communication unit may include short-range devices (e.g., a Bluetooth® device, ZigBee module, or radio-frequency identification device) or medium range (e.g., Wi-Fi devices such as a Wi-Fi hotspot). In some embodiments, the control unit 120 may be configured to pair with the user device 450 or otherwise be accessible and controlled from the user device 450 via an application 453. In some embodiments, the application may be a mobile application installed on the mobile device or a web page accessible via the web.

As illustrated in FIGS. 1A and 1B, the control unit 120 can comprise plugs 121 for receiving various temperature sensors. The temperature sensors can be used to monitor the temperature within the cooking chamber and, as illustrated in FIG. 4, indicate to a user accessing a user device 450 the temperature within the cooking chamber via the system 400 illustrated in FIG. 4. When the temperature sensors are plugged into the temperature sensor plugs 121 the temperature sensors can provide temperature information to temperature sensor unit 420. Pursuant to instructions stored in the memory device 425 of the control unit 120, the processor 424 can cause the wireless unit 422 to transmit the temperature information to the user device 450. In some embodiments, the control unit 120 can comprise a fan control unit 424 configured to adjust the speed of the fan based on the temperature information measured by the temperature sensors. In other embodiments, a user may be able to control the speed of the fan unit 130 based on the temperature measurements provided to the mobile device (as discussed above). For instance, in some embodiments, the user may identify a predetermined temperature at which the cooking chamber should be at and maintain the predetermined temperature by adjusting the speed of the fan unit 130.

The temperature adjustment unit 100 and therefore the fan of the temperature adjustment unit 100 may typically be powered by batteries, though more suitably it is powered by a detachable electric cord which may be plugged directly into an electrical outlet. For instance, an electric cord can be plugged into the side plug 122 of the temperature adjustment unit 100.

Because of the temperatures at which it operates, the temperature adjustment unit, including the fan, control unit, and outer casing, may be made out of a heat-resistant material. In some embodiments, only the outer casing of the temperature adjustment unit may be made out of a heat-resistant material.

1. A temperature adjustment unit for a fuel-burning grill comprising a grill body and a cooking chamber, the temperature adjustment unit comprising:
a fan unit; and
a temperature sensor unit operatively coupled to the fan unit, the temperature sensor unit configured to detect an interior temperature of the fuel-burning grill;
wherein when the interior temperature of the cooking chamber reaches a first temperature, the fan unit is configured to operate at a first speed to adjust the interior temperature of the cooking chamber to approximately a first predetermined temperature.

2. The temperature adjustment unit of claim 1, further comprising a control unit operatively coupled to the fan unit and the temperature sensor unit, wherein the control unit is configured to cause the fan unit to operate at the first speed.

3. The temperature adjustment unit of claim 2, wherein the temperature sensor unit comprise at least one plug for receiving a temperature sensor probe.

4. The temperature adjustment unit of claim 3, further comprising an outer casing enclosing the fan unit and the control unit, wherein the outer casing comprises a front face comprising a vent and at least one cover for covering the at least one plug of the temperature sensor unit.

5. The temperature adjustment unit of claim 2, wherein the control unit comprises a wireless unit configured to couple the temperature control device with a user device such that the fan unit can be controlled remotely from the user device.

6. The temperature adjustment unit of claim 5, wherein the temperature sensor units obtain temperature data and the control unit is configured to transmit the temperature data for display on the mobile device of the user.

7. The temperature adjustment unit of claim 1, wherein the fan unit is configured to operate in a starting fan mode in which the fan unit provides air to the cooking chamber to heat the cooking chamber.

8. The temperature adjustment unit of claim 1, wherein when an interior temperature of the cooking chamber reaches a second temperature, the fan unit is configured to operate at a second speed to adjust the interior temperature of the cooking chamber to a second predetermined temperature.

9. The temperature adjustment unit of claim 8, wherein the first and second predetermined temperature are based on part on settings provided by a user.

10. The temperature adjustment unit of claim 1, further comprising an attachment unit configured to releasably couple the temperature adjustment unit to the grill body.

11. The temperature adjustment unit of claim 10, wherein the attachment unit comprises a track system configured to slide the temperature adjustment on the grill body.

12. A temperature adjustment unit for a fuel-burning grill, the temperature adjustment unit comprising:
a fan unit;
a control unit operatively coupled to the fan unit;
an outer casing enclosing the fan unit and the control unit, the outer casing comprising:
a vent disposed on a front-most portion of the casing, the vent configured to remove exhaust from the fan unit;
a temperature sensor unit configured to detect an interior temperature of the fuel-burning grill, the temperature sensor unit operably coupled to the control unit and the fan unit and configured to cause the fan unit to operate at a plurality of different modes to adjust the interior temperature of the fuel-burning grill.

13. The temperature adjustment unit of claim 11, wherein the plurality of different modes include a start mode and a bellows mode.

14. The temperature adjustment unit of claim 11, further comprising an attachment unit configured to releasably couple the temperature adjustment unit to a grill body of the fuel-burning grill.

15. The temperature adjustment unit of claim 14, wherein the attachment unit comprises a track system configured to slide the temperature adjustment on the grill body.

16. The temperature adjustment unit of claim 11, wherein the control unit comprises a wireless unit configured to wirelessly couple the temperature adjustment unit to a mobile device of a user.

17. A multi-modal fan system for controlling the temperature within a fuel-burning grill, the multi-modal fan system comprising:
a fan unit comprising a rotor and a rotor cover;
a control unit operatively connected to the fan unit, the control unit comprising a temperature sensor unit configured to detect an internal temperature of the fuel-burning grill;
wherein the control unit is configured to cause the fan unit to operate in a starter fan mode and a bellows fan mode.

18. The multi-modal fan system of claim 17, wherein the control unit further comprises a wireless unit configured to wirelessly couple with a mobile device and wherein the control unit causes the fan unit to operate in a starter fan mode and a bellows fan mode responsive to receiving an instruction from the mobile device.
